(19) United States
(12) Patent Application Publication
(10) Pub. No.: US 2008/0235297 A1
(43) Pub. Date: Sep. 25, 2008

(54) Method for Indexing a Large Log File, Computer-Readable Medium for Storing a Program for Executing the Method, and System for Performing the Same

(75) Inventor: Ul-Suk Lee, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Innerbus Co., Ltd.

(21) Appl. No.: 11/742,780

(22) Filed: May 1, 2007

(30) Foreign Application Priority Data
Mar. 22, 2007 (KR) 10-2007-0028161

(51) Int. Cl. G06F 17/30

(52) U.S. Cl. 707/202

(57) ABSTRACT

A system for performing a method for indexing a large log file includes a log line indexing section, a character string matching report file and a file pointer list file. The log line indexing section receives a character string by a user operation to extract a log line comprising the corresponding character string from an original log file, and counts the number of the file pointers. The character string matching report file stores the character string and the number of the file pointers corresponding to the character string. The file pointer list file stores the file pointers of the original log file corresponding to the character string. Therefore, the size of the “found” log file corresponding to the found log lines may be decreased, which are found in a log analysis that searches for and analyzes log lines including a specific character string in a large log file.

### CROSS-REFERENCE TO RELATED APPLICATIONS

This application claims priority under 35 U.S.C. § 119 to Korean Patent Application No. 2007-28161, filed on Mar. 22, 2007 in the Korean Intellectual Property Office (KIPO), the contents of which are herein incorporated by reference in their entirety.

### BACKGROUND OF THE INVENTION

1. Field of the Invention

The present invention relates to a method for indexing a large log file, a computer-readable medium for storing a program for executing the method, and a system for performing the method. More particularly, the present invention relates to a method for indexing a large log file capable of decreasing a storage capacity, a computer-readable medium for storing a program for executing the method, and a system for performing the method.

2. Description of the Related Art

Generally, Web site owners and Web site builders are interested in various statistics, such as who is browsing a Web site, what content users are requesting or downloading from a Web site, and when users are requesting or downloading content from a Web site. This type of information may be useful for determining the content, designs, or marketing campaigns that attract site visitors, retain them, and induce online purchasing decisions. Typically, Web site activity information is stored in log files on a Web server as the activity occurs.

A log is a record of computer activity used for statistical purposes as well as troubleshooting and recovery. Many log files store information, such as incoming command dialog, error and status messages, and transaction detail. Web server logs are a rich source of information about user activity that a Web server automatically creates.

A Web site owner or Web site builder analyzes the log file in order to objectively evaluate the effect of advertising or a change in management type to efficiently manage a company. The log file may be used to increase earnings through effective target advertising or consulting.

When confirmation of log line information as well as statistics is necessary, original log lines that are found in a search are stored in a different file. Therefore, the number of found log lines and log lines based on the number of found log lines may be confirmed. The above information may be used in a trend analysis of visitors visiting the Web site, and may also be used in the security field, which typically requires clear search results.

However, when many log lines are found in a large log file, the size of the “found” log file increases. For example, when a specific character string, for example, if many logs containing ‘NETBIOS’ are found in a 10 GB log file so that the “found” log file increases to a capacity of 1 GB, it is not only difficult to open the “found” log file but it is also difficult to store the “found” log file. In order to store the “found” log file, an expensive database (DB) has to be built.

Furthermore, since the “found” log file is a copy, the “found” log file may not be considered as evidence when a hacker maliciously accesses the Web site.

### SUMMARY OF THE INVENTION

The present invention provides a method for indexing a large log file capable of decreasing the size of a “found” log file including a plurality of log lines that are checked in correspondence with a specific character string in a large log file.

The present invention also provides a computer-readable medium for storing a program for executing the method for indexing a large log file.

The present invention also provides a system for performing the method for indexing a large log file.

In one aspect of the present invention, there is provided a method for indexing a large log file. The method comprises: (a) receiving a character string for a log analysis from a user; (b) reading a first log line stored in an original log file; (c) checking whether or not the character string is included in the read log line; (d) adding to a number of found character strings when the character string is included in the log line in step (c), and storing a file pointer of the found log line; (e) checking whether or not the original log file has ended when the character string is not included in the log line in step (c); (f) reading a following log line when the log file is checked as not having ended in step (e), and feeding back to step (c); and (g) ending the processes when the log file is checked as having ended in step (e).

In another aspect of the present invention, there is provided a computer-readable medium for storing a program for executing a method for indexing a large log file to perform steps of: (a) receiving a character string for a log analysis from a user; (b) reading a first log line that is stored in an original log file; (c) checking whether or not the character string is included in the read log line; (d) adding to a number of found character strings when the character string is included in the log line in process (c), and storing a file pointer of the found log line; (e) checking whether or not the original log file has ended when the character string is not included in the log line in process (c); (f) reading a following log line when the log file is checked as not having ended in process (e), and feeding back to process (c); and (g) ending the processes when the log file is checked as having ended in process (e).

In still another aspect of the present invention, a system for performing a method for indexing a large log file includes a log line indexing section, a character string matching report file and a file pointer list file. The log line indexing section receives a character string by a user operation to extract a log line comprising the corresponding character string from an original log file, and counts the number of the file pointers. The character string matching report file stores the character string and the number of the file pointers corresponding to the character string. The file pointer list file stores the file pointers of the original log file corresponding to the character string.

According to the method for indexing a large log file, the computer-readable medium for storing a program for executing the method, and the system for performing the method, the size of the “found” log file corresponding to the found log lines may be decreased, which are found in a log analysis that searches for and analyzes log lines including a specific character string in a large log file.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating a log file indexing system according to an exemplary embodiment of the present invention;

FIG. 2 is a graphical user interface (GUI) image illustrating an example of the character string pattern input screen of FIG. 1;

FIG. 3 is a GUI image illustrating a comparing operation between a log line and a character string pattern;

FIG. 4 is an image illustrating a file in FIG. 1 that stores only file pointers of log lines that are found;

FIG. 5 is a GUI image illustrating an example of a report screen illustrating the number of matches in a report file;

FIG. 6 is a GUI image illustrating an example of a report view according to an exemplary embodiment of the present invention;

FIG. 7 is a schematic diagram illustrating the operation of the log line searching module of FIG. 1; and

FIG. 8 is a flow chart illustrating a method for indexing a log line using a file pointer according to an exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the present invention will be described in detail with reference to the accompanying drawings.

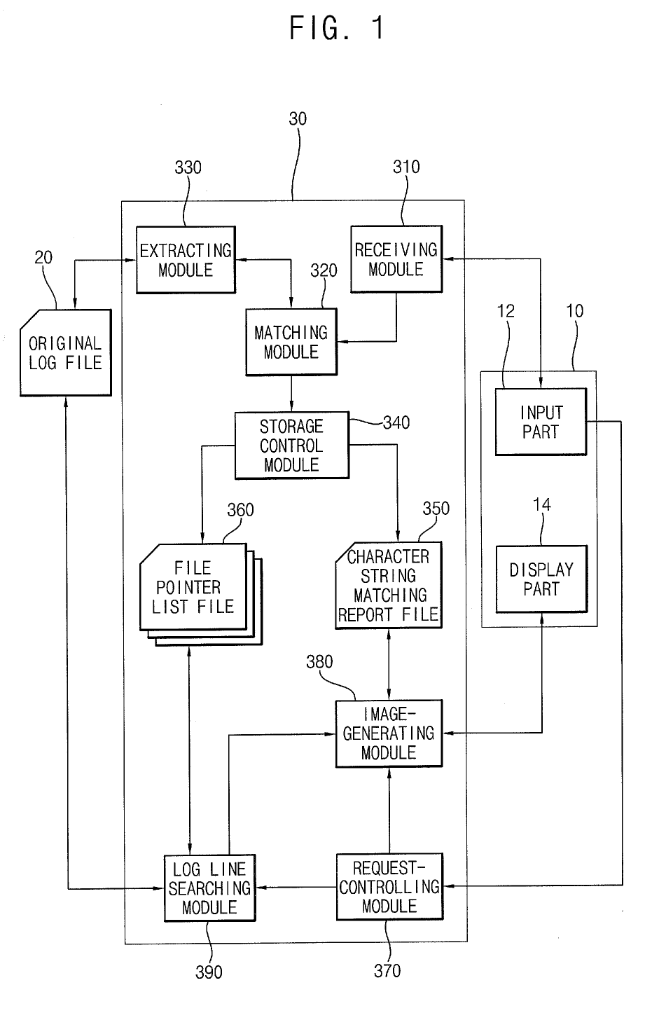

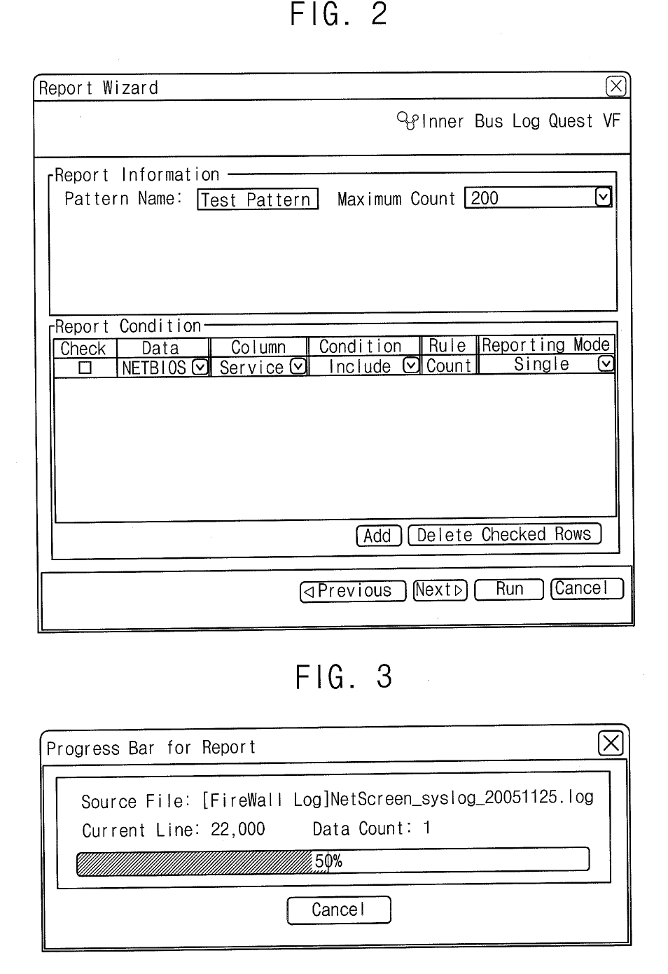

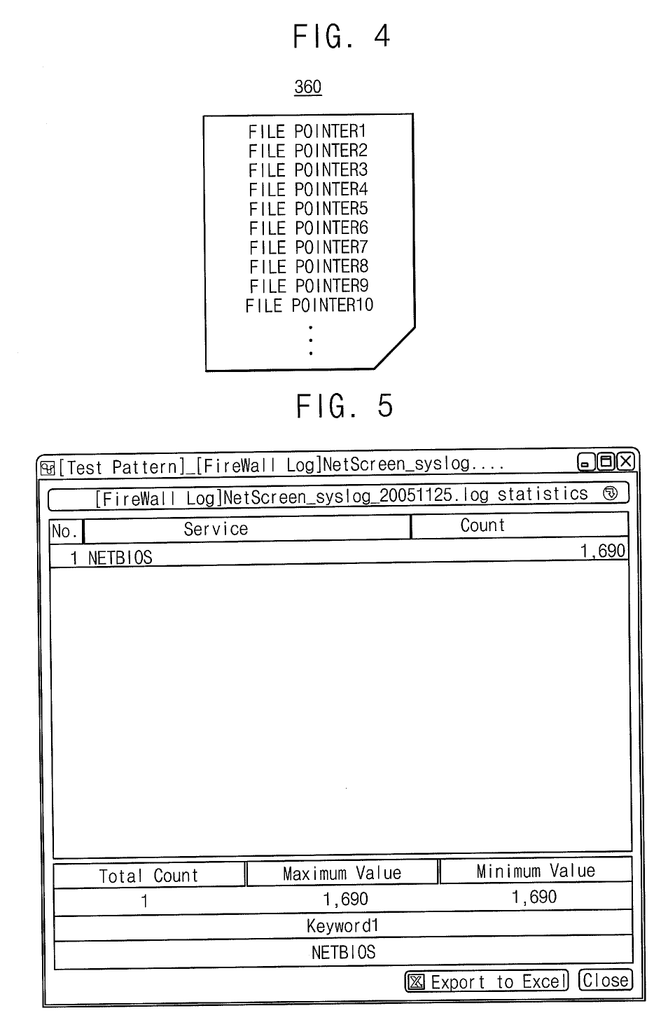

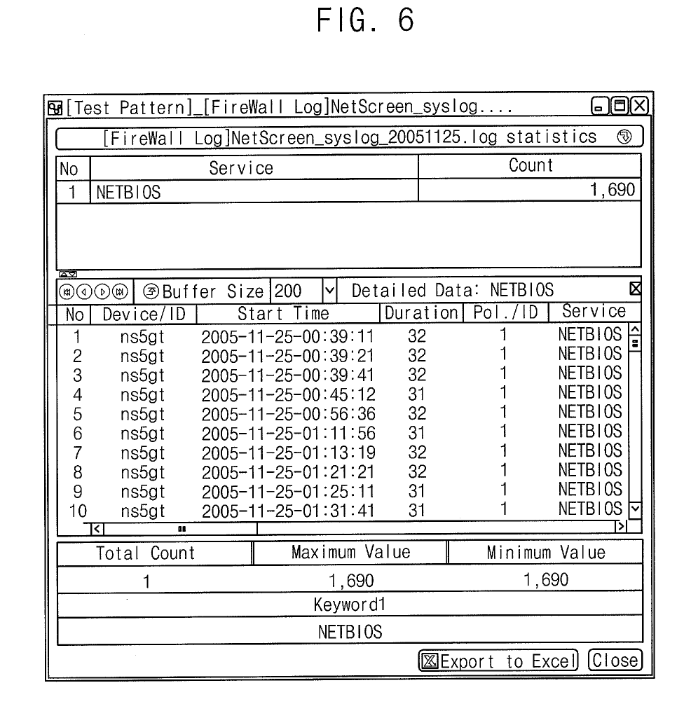

FIG. 1 is a block diagram illustrating a log file indexing system according to an exemplary embodiment of the present invention. FIG. 2 is a graphical user interface (GUI) image illustrating an example of a character string pattern input screen of FIG. 1. FIG. 3 is a GUI image illustrating a comparing operation between a log line and a character string pattern. FIG. 4 is an image illustrating a file of FIG. 1 that stores only file pointers of the log lines that are found. FIG. 5 is a GUI image illustrating an example of a report screen illustrating the number of matches in a report file. FIG. 6 is a GUI image illustrating an example of a report view according to an exemplary embodiment of the present invention.

Referring to FIG. 1, a log file indexing system 30 according to an exemplary embodiment of the present invention includes a receiving module 310, a matching module 320, an extracting module 330, a storage control module 340, a character string matching report file 350, a file pointer list file 360, a request-controlling module 370, an image-generating module 380 and a log line searching module 390. The log file indexing system 30 is separately described in logical terms for ease of understanding, whether or not they are separate physical hardware elements.

In the present embodiment, the receiving module 310, the matching module 320, the extracting module 330 and the storage control module 340 may define a log line indexing section. The log line indexing section receives a character string inputted by a user operation, and extracts a log line including the character string in the original log file 20. Then, the log line indexing section stores at least one of file pointers corresponding to the extracted log line in the file pointer list file 360. Then, the log line indexing section counts the number of file pointers, and stores the counted number of the file pointers to the character string matching report file 350.

In the present embodiment, the request-controlling module 370, the image-generating module 380 and the log line searching module 390 may define a log file searching section. The log file searching section receives a log searching request signal inputted by a user operation, and extracts the number of the counted file pointers from the character string matching report file 350 to provide the number of the counted file pointers to a display part 14 of the input/output (I/O) section 10. The log file searching section searches for the stored log lines in the original log file 20 using the stored file pointers stored in the file pointer list file 360, and provides the display part 14 of the I/O section 10 with the search results.

The receiving module 310 receives a character string pattern provided from an input part 12 such as a keyboard or a mouse that is equipped to the I/O section 10, and provides the matching module 320 with the character string pattern. For example, the receiving module 310 provides a display part 14 of the I/O section 10 with a screen for inputting the character string, as shown in FIG. 2, when an indexing request of a large log file is provided from a user system. The receiving module 310 receives the character string pattern inputted by the input part 12 and provides the matching module 320 with the character string pattern.

The matching module 320 provides the extracting module 330 with the character string pattern so as to search for a log line corresponding to the character string pattern.

The extracting module 330 receives an extracting request of a character string from the matching module 320, and sequentially extracts log lines from the original log file 20. The extracting module 330 provides the matching module 320 with the extracted log lines. Therefore, the matching module 320 parses an original log line provided from the extracting module 330, and determines whether or not the character string pattern inputted by a user is in the parsed log line.

The operation of the matching module 320 and the extracting module 330 is organically performed as shown in FIG. 3, and is performed until the last of the log lines stored in the original log file 20 is reached.

When the character string pattern is in the extracted original log line, the storage control module 340 may add to the number of matches recorded in the character string matching report file 350. For example, when the character string pattern is found for the first time, the storage control module 340 may store the character string and ‘1’ as the number of matches in the character string matching report file 350. Alternatively, when a plurality of character string patterns are found, the storage control module 340 may add to the number of matches corresponding to the character string pattern.

The character string matching report file 350 stores the character string and the number of file pointers counted in correspondence with the character string. Here, the character string and the number of file pointers stored in the character string matching report file 350 may be stored in the character string matching report file 350 as shown in FIG. 6. That is, a character string such as ‘NETBIOS’ and a number of the file pointers such as ‘1,690’ may be stored in the character string matching report file 350.

The file pointer list file 360 stores the file pointers of the log lines stored in the original log file 20 in correspondence with the character string, as shown in FIG. 4.

The size of the file pointer list file 360 is greater than that of the character string matching report file 350, because the character string and the number of file pointers corresponding to the character string are stored in the character string matching report file 350; however, each of the file pointers corresponding to the character string is stored in the file pointer list file 360.

The request-controlling module 370 provides the image-generating module 380 with a first request signal provided from the I/O section 10, and provides the log line searching module 390 with a second request signal provided from the 1/0 section 10.

The first request signal is a signal that controls conversion of the character string and the number of counted file pointers that are stored in the character string matching report file 350 into a graph form or a table form. The second request signal is a signal that controls conversion of the original log line stored in the original log file 20 into a graph form or a table form using the file pointer stored in the file pointer list file 360.

The image-generating module 380 prepares a report screen to provide the report screen to the display part 14 of the I/O section 10.

Particularly, the image-generating module 380 converts the character string stored in the character string matching report file 350 and the number of counted file pointers in a graph form or a table form to provide the number of counted file pointers to the display part 14, based on the first request signal from the request-controlling module 370.

Referring to FIG. 5, one character string and the number of counted file pointers corresponding to the character string are displayed in the display part 14. In the present exemplary embodiment, the character string displayed in the display part 14 is ‘NETBIOS’, and the number of counted file pointers displayed in the display part 14 is 1,690. Here, when a user clicks the corresponding character string, the number of files counted in correspondence with the character string may be displayed in so-called a bar graph form. Alternatively, the number of files counted in correspondence with the character string may be extracted in a Microsoft Excel file form. When a plurality of character strings exist, the number of counted files corresponding to each character string may be displayed in a plurality of bar graphs.

Additionally, the image-generating module 380 converts the found log lines provided from the log line-detecting module 390 into a graph form or a table form to provide the found log lines to the display part 14.

The log line searching module 390 reads the file pointers stored in the file pointer list file 360 based on the second request signal from the request-controlling module 370. Then, the log line detecting module 390 reads the original log line stored in the original log file 20 using the read file pointers, and provides the original log lines to the image-generating module 370. Therefore, the image-generating module 370 generates image information as shown in FIG. 6.

Referring to FIG. 6, a service character string such as ‘NETBIOS’ is found 1,690 times in the predetermined log file, and the original log lines corresponding to position addresses (hereinafter, a file pointer) of each of the 1,690 log lines are displayed. Particularly, a predetermined service character string and the number of file pointers that are counted in correspondence with the predetermined service character string are displayed in an upper portion area of FIG. 6. The log information having the original log lines corresponding to each of the file pointers are displayed in a middle portion area of FIG. 6. The log information may include an identification of a device, a processing time, a policy ID, etc.

The operation of the log line searching module 390 may be rearranged following a pseudo-code.

```
Class Searcher
{
  //BEGIN
  public void Searcher(String file, String searchData)
  {
    if (The file does not exist) return;
    if (The index-file does exist)
    {
      //Index-File Reading
      ResultRecord[ ] rsultData = readIndex(file, searchData);
      //Result data is put into the GUI (table).
      for(int i=0; rsultData.length; i++)
      {
        data put into Table
      }//end for
    }
  }
  //Index-File Reading
  private ResultRecord[ ] readIndex(String file, String searchData)
  {
    //Get a file pointer.
    FilePointer[ ] pointer = getFilePointer(handler.searchName);
    ResultRecord[ ] rcd = new ResultRecord[pointer.length];
    //read File Stream
    RandomAccessFile raf = new RandomAccessFile(file, “rw”);
    for(int i = 0; i<pointer.length; i++)
    {
      raf.pointer(pointer[ I ]);//file pointer move
      rcd[i] = raf.readLine( );//read line
    }//end for
    return rcd;
  }
  //Get a file pointer.
  private FilePointer[ ] getFilePointer(String pointerName)
  {
    return (search pointerName)
  }
}//end class
```

As described above, the log file indexing system 30 searches for log lines including a predetermined character string inputted by a user in the large original log file 20, and may prepare statistics of the log lines for a log analysis.

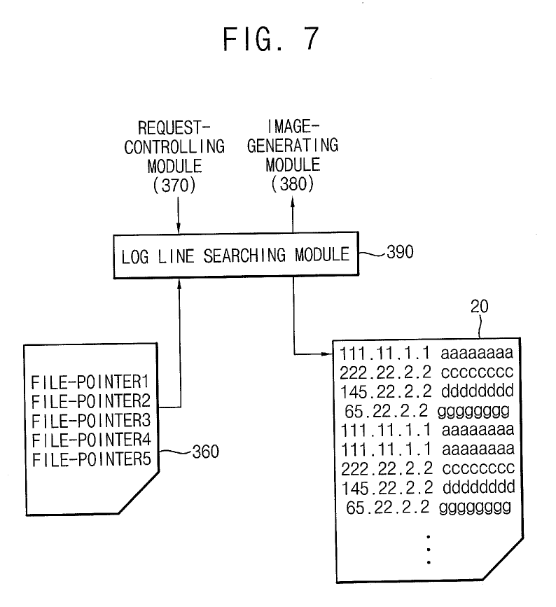

Particularly, the log line storage system 30 searches for the log lines corresponding to the character string inputted through the I/O section 10 in the original log file 20, and separately stores the file pointers corresponding to the found log lines. The file pointers are stored in separate file form, and not in an expensive database. For example, the log file indexing system 30 may prepare statistics for log analysis of the number of accesses of an access device having an Internet Protocol (IP) address of <111.111.11.1>. The above-mentioned approach is illustrated in the following FIG. 7.

FIG. 7 is a schematic diagram illustrating the operation of the log line searching module of FIG. 1. Particularly, FIG. 7 is a schematic diagram illustrating that the log line corresponding to the file pointer is read from the original log file.

Referring to FIGS. 1 and 7, the log line searching module 390 reads the file pointers stored in the file pointer list file 360, based on a signal that requests an extracting of an original log line from the request-controlling module 370. Then, the log line searching module 390 reads the original log lines stored in the original log file 20 using the read file pointers, and provides the original log lines to the image-generating module 370. Therefore, a capacity of a “found” log file may be decreased, and the found original log line may be identified so that the file pointers may be used as evidence data for various types of Web accesses.

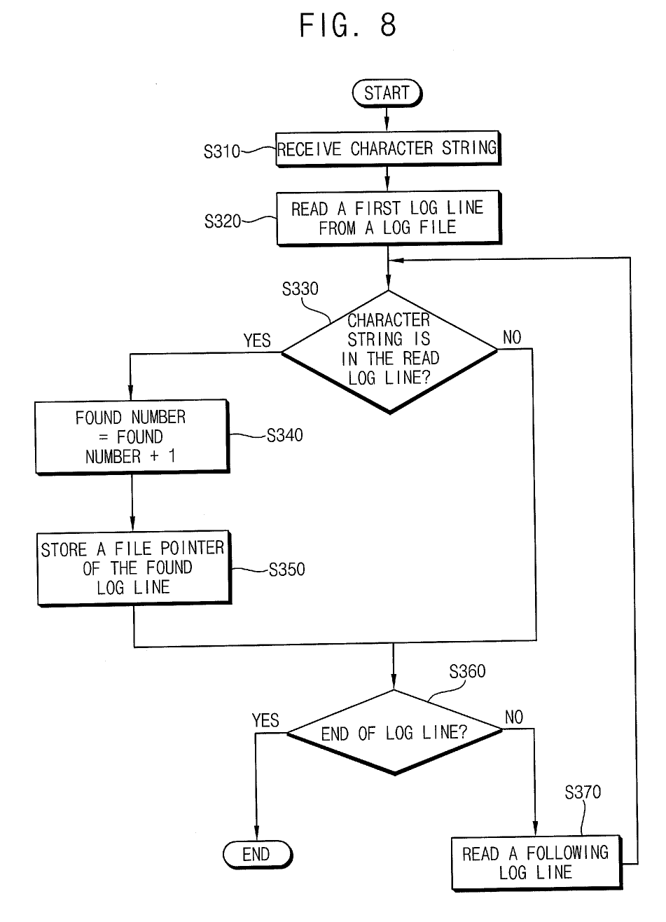

FIG. 8 is a flow chart illustrating a method for indexing a log line using a file pointer according to an exemplary embodiment of the present invention.

Referring to FIGS. 1 to 8, the character string receiving module 310 receives a predetermined character string for a log analysis from the I/O section 10 (step S310). For example, the predetermined character string may include <111.11.1.1> as an IP address.

Then, the log line extracting module 320 reads a first log line from the original log file 20 (step S320).

Then, the character string pattern matching module 330 checks whether or not the predetermined character string is includes in the read log line (step S330).

In step S330, when the predetermined character string is in the log line, the number of found log lines is added by ‘1’ and then the added to the number of found log lines stored in the character string matching report file 350 (step S340).

Then, a file pointer (or a position address) corresponding to the found log line is stored in the file pointer list file 360 (step S350).

Then, after the file pointer is stored in the file pointer list file 360 or when the predetermined character string is not in the log line in step S330, the character string pattern matching module 330 checks whether or not the log line stored in the original log file is the last log line (step S360).

When the log line stored in the original log file is the last log line in step S360, the log line indexing process comes to an end, when the log line stored in the original log file is not the last log line in step S360, the log line extracting module 320 reads a following log line and then feeds back to step S330 (step S370).

The method for indexing a log line as described in the FIG. 8 may be programmed, and then may be stored in a computer-readable medium.

As described above, according to the present invention, the size of a “found” log file corresponding to found log lines may be decreased, which are found in a log analysis that searches for and analyzes log lines including a specific character string in a large log file. Therefore, the log line may be stored without having to purchase an expensive database system, so that a log line storage system may be built with a low cost.

Moreover, the expensive database system is not used, and an indexing process for searching a large log file searching may be performed.

Moreover, original log line data stored in an original log file is not damaged, so that the file pointer list file may be utilized as evidence data of various types of Web accesses.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method for indexing a large log file, the method comprising:
(a) receiving a character string for a log analysis from a user;
(b) reading a first log line stored in an original log file;
(c) checking whether or not the character string is included in the read log line;
(d) adding to a number of found character strings when the character string is included in the log line in step (c), and storing a file pointer of the found log line;
(e) checking whether or not the original log file has ended when the character string is not included in the log line in step (c);
(f) reading a following log line when the log file is checked as not having ended in step (e), and feeding back to step (c); and
(g) ending the processes when the log file is checked as having ended in step (e).

2. The method of claim 1, wherein the number of found character strings is stored in a character string matching report file.

3. The method of claim 1, wherein the file pointer is stored in a file pointer list file.

4. A computer-readable medium for storing a program for executing a method for indexing a large log file, the computer-readable medium comprising:
(a) receiving a character string for a log analysis from a user;
(b) reading a first log line that is stored in an original log file;
(c) checking whether or not the character string is included in the read log line;
(d) adding to a number of found character strings when the character string is included in the log line in process (c), and storing a file pointer of the found log line;
(e) checking whether or not the original log file has ended when the character string is not included in the log line in process (c);
(f) reading a following log line when the log file is checked as not having ended in process (e), and feeding back to process (c); and
(g) ending the processes when the log file is checked as having ended in process (e).

5. A system for performing a method for indexing a large log file, the system comprising:
a log line indexing section receiving a character string by a user operation to extract a log line comprising the corresponding character string from an original log file, and counting the number of the file pointers;
a character string matching report file storing the character string and the number of the file pointers corresponding to the character string; and
a file pointer list file storing the file pointers of the original log file corresponding to the character string.

6. The system of claim 5, wherein the log line indexing section comprises:
a receiving module receiving the character string pattern provided from an input/output (I/O) section;
an extracting module sequentially extracting the log lines from an original log file;
a matching module parsing an original log line provided from the log line extracting module and checking whether or not the character string inputted from a user is in the parsed log line; and
a storage control module adding to a number of found character strings when the character string is included in the original log line to store a file pointer of the found log line in the character string matching report file, and storing the file pointer corresponding to the found log line corresponding to the character string in the file pointer list file.

7. The system of claim 5, further comprising:
a log file searching section receiving a log searching request signal by a user operation, and extracting the number of counted file pointers from the character string matching report file to provide a display section with the number of counted file pointers.

8. The system of claim 7, wherein the log file searching section receives the log searching request signal by a user operation, and extracts file pointers of the original log file from the file pointer list file to further provide the display section with the extracted the file pointers.

9. The system of claim 5, wherein the log file searching section comprises:
a request control module receiving a first request signal from an 1/O section; and
an image-generating module receiving the first request signal from the request control module, and displaying a number of matches corresponding to the character string pattern.

10. The system of claim 9, wherein the request control module further receives a second request signal from an I/O section,
wherein the log file searching section further comprises:
a search module receiving the second request signal from the request control module, and searching for the corresponding log line from the original log file based on the second request signal from the request control module.

11. The system of claim 10, wherein the image-generating module displays a file pointer corresponding to a number of matches corresponding to the character string pattern.
